(19) United States
(12) Patent Application Publication
(10) Pub. No.: US 2009/0011109 A1
(43) Pub. Date: Jan. 8, 2009

(54) Method For Producing a Casing-Less Sausage or Similar Type Food Product and Product Thus Obtained

(75) Inventors: Alicia Espeleta Vega, Monterrey (MX); Cesar Dalmacio Mora Castillo, Tultepec (MX)

Correspondence Address: MICHAEL WINFIELD GOLTRY, 4000 N. CENTRAL AVENUE, SUITE 1220, PHOENIX, AZ, 85012, US

(73) Assignee: SIGMA ALIMENTOS, S.A. DE C.V., San Pedro Garza Garcia (NL)

(21) Appl. No.: 12/097,514

(22) PCT Filed: Dec. 15, 2006
(86) PCT No.: PCT/MX2006/000144

§ 371 Date: Jun. 13, 2008

(30) Foreign Application Priority Data
Dec. 16, 2005 (MX) NL/A/2005/000101

(51) Int. Cl. A23L 1/317

(52) U.S. Cl. 426/574; 426/516; 426/511; 426/645

(57) ABSTRACT

A process for elaborating a casing-less sausage- or similar-type food product, the process comprises the steps consisting in preparing an emulsion-type sausage paste having a gel-like viscosity; extruding the sausage paste into portions of a predetermined shape, which maintain said shape and which have at least one essentially flat surface; cooking the upper and lower surfaces of the said portions in order to form a skin that is obtained by applying heat to the external sausage paste of said portions, thereby leaving a core which is surrounded by the skin and which consists of the sausage paste that was not used to form the skin; performing a second cooking step in order to cook the cores, thereby forming sausage-type food products; and finally cooling the sausage-type food products prior to packing. The product thus obtained consists of a body which has at least one essentially-flat surface and which has a skin that is obtained upon heating, and a core which is surrounded by the skin and which consists of the cooked sausage paste that was not used to form the skin.

### TECHNICAL FIELD OF THE INVENTION

The present invention relates to a process for the elaboration of meat food products, and more particularly, to a process for elaborating of a casing-less sausage or similar type food product and with a special form different from the classic conventional form, as well as the food product obtained through this process.

### BACKGROUND OF THE INVENTION

At present there are numerous variants of sausages, such as sausages for cooking on a fire and/or smoking, sausages for cooking on a hotplate, sausages for baking, uncooked sausages, dry or semi-dry ones, etc. with or without a skin or a casing. These sausages can have different forms: straight, curves, round, or horseshoe-shaped, with the two ends of the sausage more or less separated between each other, and linked to each other through strings or end strings and the closing of the sausage, put together directly or indirectly by means of a supplementary link; an open ring such as described by Ercel Culp in the U.S. Pat. No. 3,180,737; in form of a round disk, oval, elliptic, or flattened or rectangular parallelepiped, such as described by Peter Pfleiderer in the German patent DE-2,406,090, and by Busso Freres Salaisons Villett in the French patent FR-2,379,985.

The aforementioned sausages are made according to one out of the following two procedures: introduction into a skin or casing which former end have been previously closed and the other end is closed after filling the tubular coating with the edible contents, as described by Vytautas Kupcikevicius and Joseph A. Nausedas in the U.S. Pat. No. 3,860,996; molding through the corresponding mold of the required final product as described in formerly mentioned patents FR-2,379,985 and DE-2,406,090 that are described hereunder.

The German patent DE-2,406,090 describes a cooking sausage, flat-formed as an elliptical disk, wrapped in a skin. The sausage meat is molded, compressed, and is presented in the form of a disk mold and later warmed up, until then without any skin. Next, a skin, that is, an edible, coagulable substance such as the sodium alginate is applied over the meat mass of the sausages by pulverization or immersion.

The French patent FR-2,379,985 describes a sausage product in the form of a circular or oval disk, or in the form of a flat or rectangular parallelepiped. A coating cellophane sheet is situated at the bottom of a mold, and next the food paste of the sausage is compressed in the mold and the coating is closed around the food paste. The premolded food paste is placed on a grill, subject to cooking on a fire and later on dried. Next, the initial coating is taken off, which for its nature will not adhere to the edible contents. Finally, the cooked food paste is warmed up on a fire, dried, and freed of the coating in a bath of food jelly, and preferably being seasoned with spices.

Additionally, there are other systems and processes on the market for the elaboration of sausages, such as the process of co-extrusion that is based on the principle of simultaneous extrusion of a sausage food paste and of a collagen. Thus, a continual flow of sausage food paste and collagen are co-extruded through an injector by two separate pumps. Immediately afterwards, the co-extruded sausages leave the injector, these pass through a bath of potassium chloride to start the formation of an external matrix of collagen. Next, the product passes through a rotary cutter to cut and form the sausage conventionally, later a pre-drying is performed to form the initial crossed links of the protein, the liquid smoke is added, and next the following drying and the cooking, drying, packing, and a probable pasteurization.

Timohty G. MaLLy, in the Spanish patent ES-2,046,702, describes an equipment to form a casing less sausage or similars, the equipment has means for filling and forming a fluid food paste to make an elemental piece of a determined form; means for cooking in order to form a proteinic skin starting out from the food paste material of one part of the surface of an elemental piece in order to produce an elementary piece that has an external surface that includes a proteinic skin and part of a core that includes food paste material that was not formed into proteinic skin; means for extruding to remove one of the elemental pieces from the filling and forming means; and transportation means to receive and take an elemental piece that was removed by the extrusion means so that the transportation means have a way to form the ends to be applied to the food paste material and at least to one end of the received elemental material by the transportation means, and to form the end of the food paste material, giving it a general rounded configuration by the rotary movement between one of the elemental pieces and the means for creation of the ends so that in the end a product if created in the form of a conventional sausage.

Timohty G. Mally, Gary A. Andel, Nilang Patel and Dean F. Shwarz, in the publication of the Mexican patent application MX-9204690, describe a system for the creation of a casing less sausage or similar, the system has a flow production means for providing an elongated flow of a proteinic food paste material, where this elongated flow possesses a proteinic casing and a part of a core that includes food paste material that has not taken part in the formation of the proteinic casing; cutting means for cutting the elongated flow of the proteinic food paste material in a diversity of uncut pieces with two unfinished ends; means for the creation of the unfinished ends to form these ends and thus making the sausage units; and a cooking means to warm up and cook the sausages that were made. Moreover, the system has transportation and permanence means to transport and receive and the elongated flow of proteinic food paste material to the cutting means, and to provide a permanence time during which the proteinic casing thickens; and a means to transfer the diversity of uncut pieces to the means where the unfinished ends are produced.

Andrea Breu and Hubert Kott, in the Spanish patent ES-2,172,064, describe a procedure to elaborate an edible sausage, in particular a roasted sausage where a sausage strip made of a mixture of sausage that contains proteins or meat, is made in a rolled form, spiral, as a cookie or another form of a sausage, the sausage is elaborated without a skin made of a mixture of the sausage so that the elaboration of the skin as well as the union of the separate rings are performed through the modification of the sausage mixture by a heat or stream treatment.

Lee Kramer, in the U.S. Pat. No. 6,203,832 B1, describes a method and an equipment to make casing less sausages and similar meat products. In such way that the emulsion of meat is extruded in a general cylindrical form, under pressure, whereas simultaneously at a room temperature of 170° F. (76.66° C.) a denaturalized solution is applied to make a cohesive surface over the extruded emulsion. Next, the extruded emulsion is submitted to a preliminary heating at a temperature of 140° F. (60° C.) to 180° F. (82.22° C.) to make segments of a length defined between the first and second ends. Finally, the segments are introduced to a cooking equipment at a temperature of 180° F. (82.22° C.) to 210° F. (98.88° C.).

Eugene R. Trippmann, in the Mexican patent MX-213,399, describes a process to produce a meat product without skin, which includes a piece of meat that is thermally treated so that it does not contain any external skin around it on its surface. The meat is located inside a cooking chamber that is hermetic to air and to steam generated from a water fountain. The steam and the pressure in the chamber is regulated in order to create an atmospheric humidity of 100% in the chamber so that any amount of water is prevented to evaporate from within the meat towards the atmosphere of the chamber. The pressure can be reduced in order to produce a low temperature vapor of 150° F. (65.55° C.) to 180° F. (82.22° C.) for the cooking of the meat product. Moreover, water may be added to a flavoring ingredient, for example, liquid smoke to give the product a flavor, and the pressure can be reduced additionally so that the formation of a thin crust on the surface of the meat product is possible.

Richard A. Mueller et al., in the publication of the Mexican patent application PA/a/2002/003832, describe a method and equipment to make an emulsion or proteinic food paste in a food product configured without the use of a gut. An appropriate provision of emulsion is foreseen and transported under pressure towards an elongated empty filling tube to form a configured emulsion of continual length. Later, the configured emulsion is directed towards a molding tube that is mounted in a sliding manner around said filling tube. A treatment fluid is directed from a supply into the interior surface of the filling tube to humidify the interior part continually of the molding tube, and therefore form a proteinic skin around the configured emulsion.

Martinus W. J. T. Kujipers and Frederik F. L. H. Ankersmit, in the publication of the Mexican patent application PA/a/2004/003751, describe a method to create bent products of meat that involve extruding an elongated meat thread that contains linear protein fibers in said meat from an extrusion tube of food paste of elongated hollow meat. The food paste flow through the tube is partially restricted by a restriction element in the tube. After passing by the restriction element a first longitudinal portion results of meat food paste, mainly containing extended longitudinal fibers, gradually these transform into a second longitudinal portion of fibers, ready for a random orientation. When the meat thread is submitted to heat, the uninterrupted portion inclines to have more contractions over the length in the presence of heat than over the other layer, due to the fact that this provokes the meat product to have a loop configuration. The machine that brings this method into practice contains an extrusion tube with the restriction element within it.

The state of the art formerly described to elaborate sausages or similar products without a wrapping or casing implies processes to elaborate food products in a conventional way, that is, a sausage generally cylindrical in form, whereas those processes that allow forming products of the sausage-type with singular or peculiar forms, different from the tubular form, imply molding stages in a mold or freezing stages before cooking of the products. This implies limitations in the food industry where the form of the product and its cost are important, therefore, it is necessary to provide a process to elaborate a casing-less sausage or similar type food product, and that has a singular form completely different from the classic conventional form, without the use of molds or freezing stages during the process.

### SUMMARY OF THE INVENTION

Referring to the aforementioned and in order to solve the encountered limitations, the object of this invention is to provide a process for elaborating a casing-less sausage or similar type food product, the process comprises the steps of preparing an emulsion-type sausage paste having a gel-like viscosity; extruding the sausage paste into portions of a predetermined shape, which maintain the shape and which have at least one essentially flat surface; cooking the upper and lower suffaces of the portions in order to form a skin that is obtained by applying heat to the external sausage paste of portions, thereby leaving a core which is surrounded of the skin and which consists of the sausage paste that was not used to form the skin; performing a second cooking step in order to cook the cores, thereby forming sausage-type food products; and cooling the sausage-type food products prior to packing.

Another object of the invention is also to provide a casing-less sausage or similar type food product that has a body formed by a own skin obtained by heating; and a core which is surrounded of the skin and which consists of the sausage paste that was not used to form the skin; and the body has at least one essentially-flat surface.

Finally, it is also an object of the invention to provide a composition of emulsion-type sausage paste having a gel-like viscosity to be extruded in a predetermined form, the sausage paste is formed by a mixture of one or more milled meat products; water; salt; nitrites; and one or more binders in a proportion of weight from about 1% to about 5% in relation to weight of said sausage paste.

### BRIEF DESCRIPTION OF THE FIGURES

The characteristic details of the present invention are described in the following paragraphs, together with the figures related to it, in order to define the invention, but not limiting the scope of it.

FIG. 1 is a block diagram that describes a process for elaborating a casing-less sausage or similar type food product according to invention.

FIG. 2 illustrates a frontal view of a rectangular output extrusion nozzle according to invention.

FIGS. 3A to 3D show a bodyside view, a frontal view, a top and sectional views respectively of an embodiment of a casing-less sausage or similar type food product in a form close to an elongated parallelepiped obtained by the process of the invention.

### DETAILED DESCRIPTION OF THE INVENTION

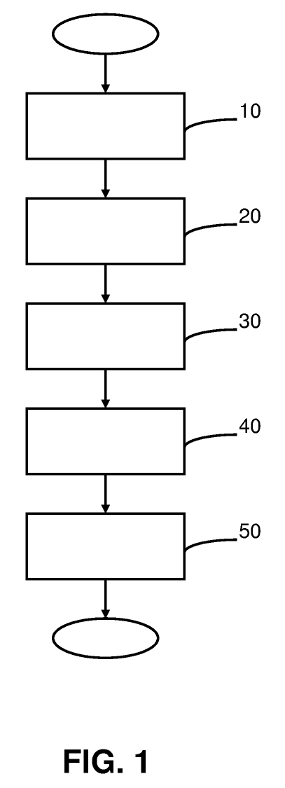

In reference to FIG. 1, a process for elaborating a casing-less sausage or similar type food product as shown, the process initiates in step 10 where an emulsion-type sausage paste having a gel-like viscosity is prepared starting from one or more meat products, such as pork or beef, whether frozen or unfrosted, that are mixed in a cutting machine with water, salt, nitrites, non-meat stuffing products, and one or more binders or gums until provoking the mayor protein extraction in order to obtain an emulsion-type sausage paste of a general homogeneous and slightly shining appearance. The binder or gum used in the mixture has a relation in weight from about 1% to about 5% in relation to the weight of the sausage paste so that the binder can be at least an hydrocolloid, such as for example, starch, jelly, alginates, carrageenans, sodium carboxymethylcellulose, xanthan, guar, or konjac, or combinations thereof, that allow stabilizing the emulsion-type sausage paste offering it a viscosity similar to gel in a range from about 1400 Pa·s to about 2550 Pa·s, which allows the sausage paste to be extruded in portions and in a predetermined form without any substantial deformation of these portions during the later stages of the process of the invention.

The viscosity of the emulsion-type sausage paste, in relation to the variations in percentage of the binder weight, can be observed in Table 1, which shows the measurements performed to a emulsion-type sausage paste sample of approximately 800 grams and an approximate temperature of 7° C. to 8° C. placed in a precipitated glass of 1000 milliliters. The measurements were performed in triplicate in a programmable viscosimeter, brand BROOKFIELD model DV-II Pro, using an RV07 spindle at a speed of 1.5 rpm.

TABLE 1

| Percentage in weight of | | | |
|---|---|---|---|
| binder used in sausage | Viscosity (Pa · s) | | |
| emulsion | Sample 1 | Sample 2 | Sample 3 |
| 1% | 1500 | 1490 | 1400 |
| 3% | 1810 | 1720 | 1800 |
| 5% | 2500 | 2550 | 2470 |

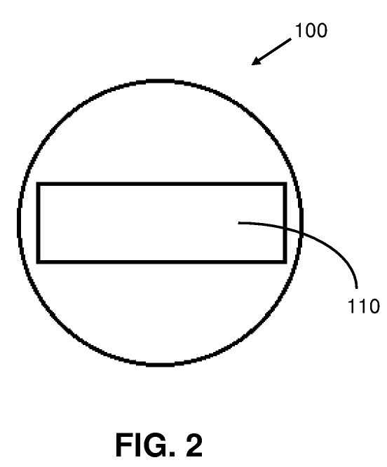

The emulsion-type sausage paste is introduced in the machine with an extruder of the type that generally has a filling hopper, and inside an extrusion press. Next, in step 20 and at an initial freezing temperature from about 0° C. to about 12° C. that allows maintaining the emulsion, the sausage paste is extruded in portions and in a predetermined form, when making it pass through the machine nozzle with the extruder, that is linked by one or more extrusion heads with one or more nozzles, and the latter in turn comprise a cutter that allows dosing the sausage paste in generally uniform portions that are extruded. The form of the nozzle used allows creating a portion of sausage paste to be extruded in a peculiar form, for example, as a round, oval, elliptic disk, or a flat or rectangular parallelepiped, or a prism, or combinations thereof, that by themselves are particular in having at least one generally flat surface. An example of an extrusion nozzle 100 with rectangular output 110 is shown in FIG. 2, which allows extruding a sausage paste in a form close to an elongated parallelepiped.

Returning to FIG. 1, each extruded and preformed sausage paste is placed on a conveyor that displaces uninterruptedly on a pulled conveyor band, under the extrusion nozzle in the direction of the extrusion and at the speed of said extrusion. Such extruded and preformed sausage paste portions are transported and introduced by the conveyor chain towards the interior of a furnace of the type with an upper heating panel and a lower heating panel, mounted one opposite the other and with space in between, adjustable, at a distance slightly bigger than the thickness of the sausage paste portions that have to be cooked.

In step 30, as the extruded and preformed sausage paste portions are introduced into the furnace, in particular into the existing space between the upper and lower heating panels, said portions are cooked, as well on their upper as lower surfaces in a generally simultaneous and homogeneous manner, to form their own skin obtained by the heating of the external sausage paste of the portions, leaving a core which is surrounded of the skin and which consists of the sausage paste that was not used to form the skin. The term “own skin” refers to the external layer of the sausage paste that was cooked by the heating applied, forming a kind of superficial crust. The cooking of the extruded and preformed sausage paste portions, in the interior of the furnace, takes place with an approximate permanence of 10 seconds until approximately 50 seconds, and at an operational temperature from about 150° C. to about 200° C., being this in general the temperature of the upper heating panel superior or equal to the temperature of the lower heating panel.

Once the sausage paste portions have been cooked, they leave with their own skin with an appearance and texture obtained according to the texture of the surface of the transporting conveyor and heating panels used, that is, for example in case heating panels are used with a coating of Teflon (PTFE), an own skin is obtained with a texture that is generally smooth, whereas in case of using a grill-type of conveyor chain, then a skin texture is obtained of the grill-type.

Next, in step 40, the portions with an own skin are submitted to a second cooking step that comprises a drying and steam baking to provoke the final cooking of the cores of the portions with their own skin, forming thus the casing-less sausage or similar type food product. This is obtained by introducing the portions with their own skin to a drying chamber that operates at a temperature from about 110° C. to about 160° C. so that the dried portions with an own skin reach an internal product temperature from about 40° C. to about 65° C. The drying in the drying chamber can be performed with the help of warm air that is blown into the interior part of the chamber. Later, the portions with an own skin and dried are steam baking when introduced in a steam chamber of the convection furnace-type that operates at a temperature from about 110° C. to about 160° C. In this step the product obtained is a casing-less sausage or similar type food product that has an internal product temperature of about 80° C.

Finally, in step 50, the casing-less sausage or similar type food product is cooled down in a cooling chamber with cold air of about 4° C. until the casing-less sausage or similar type food product reaches an internal product temperature from about 10° C. to about 15° C. to proceed to its packing.

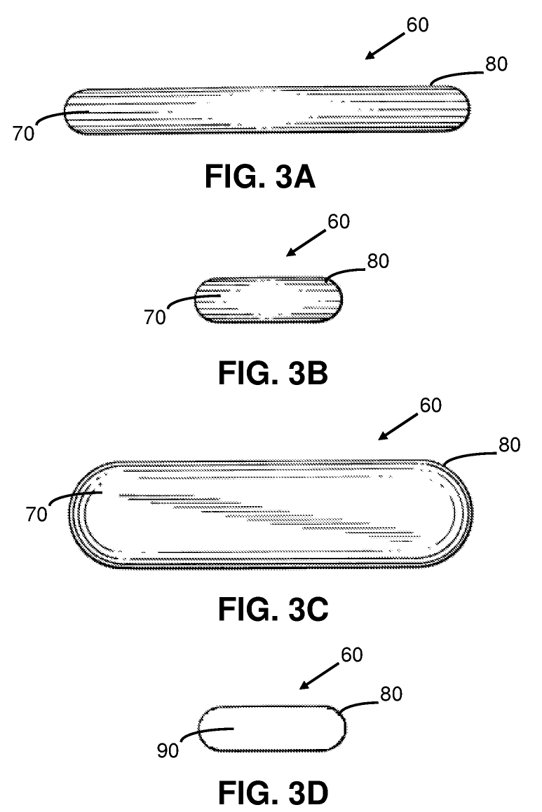

An example of the casing-less sausage or similar type food product 60, in a form close to an elongated parallelepiped that is obtained by the process of the invention, as described above, is shown in FIGS. 3A to 3D, showing a bodyside view, a frontal view, an upper view, and a sectional view, respectively. The food product 60 obtained has a body 70 with at least one surface that is generally flat, the body 70 comprises its own skin 80 obtained by heating; a core 90 which is surrounded of the skin 80 and which consists of the sausage paste that was not used to form the skin 80. In this case, the body 70 has a form of an elongated parallelepiped, however, it may have another form such as, for example, a round, oval, elliptic disk, or a prism, or combinations thereof, depending on the form of the extrusion nozzle used during the extrusion stage of the sausage paste (step 20 in FIG. 1).

The advantages of the invention in relation to the state of the art can be summarized in the following topics:
The emulsion-type sausage paste having a gel-like viscosity uses a range of binders or gums in a proportion in weight from about 1% to about 5%, in relation to the weight of the said sausage paste, which provides it with a body and viscosity in order to be extruded in portions and a predetermined form according to the form of the nozzle used, without the necessity to use guts, processes of co-extrusion, molding stages in a mold, or freezing stages to be able to change the classic form of the sausage into a peculiar, different form.
While using the furnace with an upper and a lower heating panel to form the skin itself in a uniform manner on the product, it implies having a very short residing time in the furnace, which represents a saving in time related to the current, conventional processes.
The casing-less sausage or similar type food product of the invention has a peculiar, different form compared with the classic conventional one, which represents a competitive advantage while providing, for example, a casing-less sausage or similar type food product in the form of a flat parallelepiped that allows covering the complete internal surface of a piece of bread for a “hot dog”.
Additionally, the fact that the casing-less sausage or similar type food product obtained by the invention has its own skin formed by the product itself, allows said product to have a texture with a peculiar appearance, such as for example, a smooth texture or of the type of the grill.

Based on the embodiments described above, it is considered that the modifications to the environments of the described embodiment, as well as to the environments of alternate embodiments will be considered evident for an expert in the state of the art under the present description. Therefore, it is considered that the claims cover those modifications and alternatives that are within the scope of the present invention or its equivalents.

1. A process for elaborating a casing-less sausage or similar type food product, the process is characterized by comprising the steps of:
preparing an emulsion-type sausage paste having a gel-like viscosity;
extruding said sausage paste into portions of a predetermined shape, which maintain said shape and which have at least one essentially flat surface;
cooking the upper and lower suffaces of the said portions in order to form a skin that is obtained by applying heat to the external sausage paste of said portions, thereby leaving a core which is surrounded of the skin and which consists of the sausage paste that was not used to form the skin;
performing a second cooking step in order to cook the cores, thereby forming sausage-type food products; and
cooling the sausage-type food products prior to packing.

2. The process of claim 1, wherein said emulsion-type sausage paste having a gel-like viscosity comprising:
one or more milled meat products;
water;
salt;
nitrites; and
one or more binders in a proportion of weight from about 1% to about 5% in relation to weight of said sausage paste.

3. The process of claims 1 and 2, wherein the gel-like viscosity of said emulsion-type sausage paste has a range from about 1400 Pa·s to about 2550 Pa·s.

4. The process of claim 2, wherein the binder is at least one hydrocolloid selected form a group consisting of starch, jelly, alginates, carrageenans, sodium carboxymethylcellulose, xanthan, guar, konjac, and combination thereof.

5. The process of claim 1, wherein the step of extruding said sausage paste into portions of a predetermined shape is performed at an initial temperature of freezing from about 0° C. to about 12° C. in order to maintain the emulsion.

6. The process of claim 1, wherein the step of extruding said sausage paste into portions of a predetermined shape is characterized by forming a round, oval, elliptic disk, or a flat or rectangular parallelepiped, or a prism, or combinations thereof to said portions through the use of nozzles.

7. The process of claim 1, wherein the step of cooking the upper and lower surfaces of the said portions in order to form a skin, is characterized by cooking said upper and lower surface in a generally simultaneous and homogeneous manner through the use of a furnace, which including at least an upper and lower heating panel.

8. The process of claim 7, wherein the cooking of said portions in said furnace is performed at a temperature from about 150° C. to about 200° C.

9. The process of claim 7, wherein said furnace the temperature of the upper heating panel is superior or equal to the temperature of lower heating panel.

10. The process of claim 7, wherein the cooking of said portions in said furnace is performed for a period from about 10 seconds to about 50 seconds.

11. The process of claim 1, wherein the step of performing a second cooking step in order to cook the cores, thereby forming sausage-type food products comprising the steps of:
drying said portions; and
steam baking said portions.

12. The process of claim 11, wherein the steps of drying and steam baking said portions are performed at an operation temperature from about 110° C. to about 160° C.

13. The process of claim 11, wherein the step of drying said portions, the portions reach an internal product temperature from about 40° C. to about 65° C.

14. The process of claim 11, wherein the step of cooking with steam said portions, the portions reach an internal product temperature of about 80° C.

15. A casing-less sausage or similar type food product characterized by comprising:
a body including:
a own skin obtained by heating; and
a core which is surrounded of the skin and which consists of the sausage paste that was not used to form the skin;
wherein the body has at least one essentially-flat surface.

16. The casing-less sausage or similar type food product of claim 15, wherein said body has a round, oval, elliptic disk form, or a flat or rectangular parallelepiped, or a prism, or combinations thereof.

17. The casing-less sausage or similar type food product of claim 15, wherein said body has a own skin with a generally smooth or grill-type texture.

18. A composition of emulsion-type sausage paste having a gel-like viscosity to be extruded in a predetermined form, comprising:
one or more milled meat products;
water;
salt;
nitrites; and
one or more binders in a proportion of weight from about 1% to about 5% in relation to weight of said sausage paste.

19. The composition of the sausage paste of claim 18, wherein the viscosity of said sausage paste has a range from about 1400 Pa·s to about 2550 Pa·s.

20. The composition of the sausage paste of claim 18, wherein said meat products may be frozen or defrosted.

21. The composition of the sausage paste of claim 18, wherein the binder is at least one hydrocolloid selected form a group consisting of starch, jelly, alginates, carrageenans, sodium carboxymethylcellulose, xanthan, guar, konjac, and combination thereof.

22. The composition of the sausage paste of claim 18, wherein further including non-meat products as a stuffing.
